(19) United States
(12) Patent Application Publication
(10) Pub. No.: US 2026/0279868 A1
(43) Pub. Date: Sep. 17, 2026

(54) HYDROGEN STORAGE MATERIAL AND FUEL CELL CONTAINING THE SAME

(71) Applicant: PROMETHEON TECHNOLOGIES BV, Zele (BE)

(72) Inventor: Zacariah Austin HEIM, Zele (BE)

(21) Appl. No.: 19/161,938

(22) PCT Filed: Mar. 1, 2024
(86) PCT No.: PCT/EP2024/055421

§ 371 Date: Sep. 3, 2025

(30) Foreign Application Priority Data
Mar. 3, 2023 (GB) 2303172.7

(51) Int. Cl. H01M 8/18; C01B 3/0021; C01B 32/15; H01M 8/0234; H01M 8/0245; H01M 8/04082; H01M 8/24

(52) U.S. Cl. CPC H01M 8/186; C01B 3/0021; C01B 32/15; H01M 8/0234; H01M 8/0245; H01M 8/04216; H01M 8/24; C01P 2006/12; C01P 2006/40

(57) ABSTRACT

The present disclosure relates to fuel cells comprising fuel storage materials made from mesoporous N-doped carbon materials. The fuel storage materials comprise a proton conducting polymeric material and a composite material comprising a scaffold of coalesced (N-doped) carbon nanofoam particles, and a coating on the scaffold, said coating comprising N-doped graphitic carbon. The fuel storage materials allow fuel reserves to be stored inside the fuel cell, and are typically incorporated adjacent to an electrode to provide fuel to the electrode when the fuel cell is operating in redox mode.

### CROSS-REFERENCE TO RELATED APPLICATIONS

This application is a National Stage Application of PCT/EP2024/055421, filed on Mar. 1, 2024, which claims priority to United Kingdom Patent Application No. 2303172.7, filed Mar. 3, 2023, and which applications are incorporated herein by reference. To the extent appropriate, a claim of priority is made to each of the above disclosed applications.

### TECHNICAL FIELD

The present disclosure relates to a hydrogen storage material for a fuel cell, and in particular to a fuel cell comprising a hydrogen storage material. In particular, the present disclosure relates to a fuel cell configured to operate in both a redox mode and a regenerative mode. The present disclosure also relates to a fuel cell having a fuel storage material integral to the fuel cell and may therefore comprise a fuel cell/based energy storage device. The present disclosure also relates to methods of forming said fuel storage material.

### BACKGROUND

Conventional electrochemical fuel cells convert fuel and oxidant into electrical energy and a reaction product. A typical layout of a conventional fuel cell comprises a solid polymer ion transfer membrane that is sandwiched between an anode and a cathode. The polymer membrane allows protons to traverse the membrane but blocks the passage of electrons. Typically, the anode and the cathode are both formed from an electrically conductive, porous material such as porous carbon, to which small particles of platinum and/or other precious metal catalyst are bonded.

The anode and cathode are often formed at the respective adjacent surfaces of the membrane. This combination is commonly referred to as the membrane-electrode assembly, or MEA.

Typically, the polymer membrane and porous electrode layers are sandwiched between flow plates. The flow plates, in a conventional fuel cell, provide for the delivery of reactants to the anode and the cathode and the removal of reaction products. The fuel cell may include porous gas diffusion layers fabricated so as to ensure effective diffusion of gas to and from the anode and cathode surfaces as well as assisting in the management of water vapour and liquid water.

Because the voltage produced by a single fuel cell is quite low, conventionally multiple cells are connected in series with the electrically conductive, flow plate on the cathode side of one cell being placed in electrical contact with the adjacent flow plate on the anode side of the next cell.

The present invention is directed to providing improvements in the design of a fuel cell and of a fuel cell stack formed of such fuel cells.

### SUMMARY

The present disclosure relates to a composite material comprising a superstructure of coalesced (N-doped) carbon nanofoam particles that are coated with an N-doped graphitic carbon material, which finds particular use as a fuel storage material.

A composite material comprising a superstructure of composite particles, wherein said superstructure comprises:
a scaffold of coalesced carbon nanofoam particles; and
a coating on the scaffold, said coating comprising N-doped graphitic carbon;
wherein the carbon nanofoam particles may optionally be N-doped.

According to a second aspect of the present disclosure if provided a fuel storage material comprising a composite material of the first aspect of the disclosure and a proton conducting polymeric material.

According to a third aspect of the present disclosure there is provided a fuel cell comprising the fuel storage material of the second aspect of the disclosure as part of or adjacent to an electrode to provide, at least in part, said fuel to the electrode when operating in a redox mode.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future claim sets. The figures and

Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example embodiment of a fuel cell and schematically shows a fuel cell stack formed of such fuel cells; and

FIGS. 2a and 2b show SEM micrographs of the N-doped carbon nanofoam material formed in Example 1.

FIGS. 3a and 3b show TEM micrographs of the composite material.

### DETAILED DESCRIPTION

The disclosure provides a composite material and fuel cells in various arrangements which contain the composite material. The composite material comprises a superstructure of composite particles, wherein said superstructure comprises a scaffold of coalesced (N-doped) carbon nanofoam particles and a coating on the scaffold, said coating comprising N-doped graphitic carbon. The scaffold of carbon nanofoam particles itself is optionally N-doped (also referred to as (N-doped) carbon nanofoam). The disclosure also provides various examples of the composite material in different arrangements that find various uses, particularly as a fuel storage material in a fuel cell, particularly a fuel cell that can operate in conventional redox mode and in regenerative mode. Particularly preferred types (N-doped) carbon nanofoam material that finds use in examples of the disclosure will be described in more detail below.

Example embodiments of a fuel cell will be described.

In one or more embodiments, the fuel cell may be configured to operate in both a conventional redox mode, in which a fuel and an oxidant is consumed to generate an electric current and one or more reaction products, and in a regenerative mode, in which a potential difference is applied to the fuel cell and at least one of the one or more of the reaction products are electrolysed to form said fuel. Thus, one or more example embodiments of the fuel cell comprise a reversible fuel cell. In one or more examples, one or more catalyst layers are provided to enable operation in said redox mode and said regenerative mode.

In one or more embodiments, the fuel cell may include a fuel storage material as a structure or layer with, i.e., alongside or forming part of, an electrode of said fuel cell, thereby providing a store of fuel within said fuel cell. In one or more examples, the fuel storage material is provided between first and second plates that contain an active region of said fuel cell.

In one or more examples, the fuel is protons and fuel storage material is configured to store said fuel.

In one or more examples, the fuel storage material is electrically connected to an electrode.

In one or more examples, the fuel storage material comprises a composite material comprising a superstructure of composite particles, wherein said superstructure comprises:
a scaffold of coalesced (N-doped) carbon nanofoam particles; and
a coating on the scaffold, said coating comprising N-doped graphitic carbon;
and a proton conducting polymeric material, as will be described below.

It will be appreciated that the fuel cell may be configured to include said fuel storage material without being configured to operate in said redox and regenerative modes. For example, the fuel cell may be configured to operate only in the regenerative mode and thereby function to store fuel in the fuel storage material for extraction.

It will be appreciated that reference to the “fuel cell” can also be understood to refer to a stack of fuel cells given that, generally, the form of the fuel cell is replicated throughout the stack.

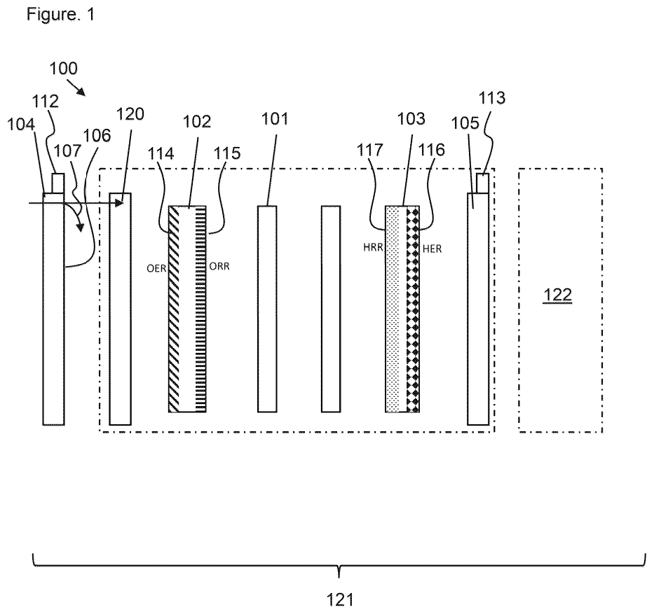

FIG. 1 shows an example fuel cell 100 according to an aspect of the disclosure. The fuel cell 100 comprises a polymer electrolyte membrane 101 or “PEM”. The PEM 101 comprises a semipermeable membrane and may be configured to conduct protons while acting as an electronic insulator and a reactant barrier.

The first plate 104 is arranged adjacent the first electrode 102, such as directly adjacent. The second plate 105 is arranged adjacent the second electrode 103, such as directly adjacent. In one or more examples, the first plate includes flow channels (not shown in FIG. 1) formed in a surface 106 thereof facing the first electrode 102. The flow channels may be configured to receive a fluid, such as an oxidant, from one or more fluid inlets (shown schematically at 107) and distribute that fluid over the surface of the first electrode 102.

Each plate 104, 105 may include a current tab 112, 113 through which an electric current may flow during use.

The fuel cell 100 may include one or more first catalyst layers 114, 115 between the first plate 104 and the polymer electrolyte membrane 101. The one or more first catalyst layers may be configured to provide an active site for catalytic activity for one or both of an oxygen reduction reaction (ORR) and an oxygen evolution reaction (OER). Suitable catalytic materials for use in the catalyst layers are described in more detail below.

In one or more examples, an OER catalyst layer may be provided at a side 114 of the first electrode facing the first plate 104. In one or more examples, an ORR catalyst layer may be provided at a side 115 of the first electrode facing the PEM 101.

In this and one or more examples, the first electrode 102 is porous and allows fluids to pass through the electrode to the PEM 101.

The fuel cell 100 may include one or more second catalyst layers 116, 117 between the second plate 105 and the polymer electrolyte membrane 101. The one or more second catalyst layers may be configured to provide an active site for catalytic activity for one or both of a hydrogen reduction reaction (HRR) and a hydrogen evolution reaction (HER).

In one or more examples, an HER catalyst layer may be provided at a side 116 of the second electrode facing the second plate 105. In one or more examples, an HRR catalyst layer may be provided at a side 117 of the second electrode facing the PEM 101.

Suitable catalytic materials for use as HER and HRR catalysts are described in more detail below.

In the present and one or more examples, the fuel cell 100 is configured to operate in a redox mode and a regenerative mode. In the redox mode the fuel cell 100 is configured to be provided with a fuel to the second electrode 103 and provided with an oxidant, such as oxygen from air, to the first electrode 102 to generate an electric current between the first and second electrodes 102, 103 and a reaction product at the first electrode 102.

In a hydrogen based fuel cell, the fuel comprises hydrogen, the oxidant comprises oxygen from air or an oxygen source, and the reaction product comprises water.

In the regenerative mode the fuel cell is configured to be provided with the reaction product, such as water in the case of a hydrogen based fuel cell, to the first electrode 102. A potential difference is to be provided between the first and second electrodes 102, 103 from an electrical power source (not shown) thereby generating said fuel, e.g., hydrogen, at the second electrode 103.

The fuel cell 100 may include a fuel storage material as part of or adjacent to the second electrode 103 to provide, at least in part, said fuel to the second electrode 103 in the redox mode and/or store, at least in part, said fuel generated at the second electrode 103 in the regenerative mode.

In this and one or more examples, the second electrode 103 is formed of said fuel storage material. Thus, the fuel storage material may be an integral part of the second electrode 103.

In other examples, the fuel storage material may comprise a distinct layer separate from the second electrode 103 but arranged adjacent to the second electrode 103 within the fuel cell 100 i.e., at least partly between the first and second plates 104, 105.

In one or more examples, the PEM is bonded to a gas diffusion layer (such as a carbon based conductor, e.g., carbon paper, carbon cloth or carbon fibre, preferably carbon paper), with the other side of the gas diffusion layer being coated with HER catalyst. This catalytic layer is adjacent to the anode, allowing facile transfer of electrons.

This configuration has been found to be advantageous when the anode acts as a fuel storage material (for instance the N-doped graphitic coated (N-doped) carbon nanofoam material and a proton conducting polymeric material described herein). In such configurations, the hydrogen evolved by the HER is also captured. If the HER is coated directly on the anode, it has been found that hotspots may occur leading to reduced efficiency of hydrogen storage.

In one or more embodiments, the fuel cell 100 includes a peripheral gasket 120 configured to be sandwiched between the first plate 104 and the second plate 105 and contain at least the polymer electrolyte membrane 101, the first electrode 102, the second electrode 103, the one or more first catalyst layers and the one or more second catalyst layers. The gasket 120 may be of silicone or vulcanized rubber. In other examples, the fuel cell 100 may be surrounded by a housing to contain said layers, the reactants and said reaction products.

In one or more examples, the fuel cell 100 may be part of a fuel cell stack 121 comprising a plurality of fuel cells arranged in series with one another. In FIG. 1, box 122 schematically represents an adjacent fuel cell to the fuel cell 100 in the fuel cell stack 121. The adjacent fuel cell 122 is substantially identical to fuel cell 100.

FIG. 1 shows a fuel cell having that capability, by virtue of the provision of appropriate catalyst layers to operate in both a redox mode and a regenerative mode, as well as having an integral fuel storage material. However, in one or more examples only some of the above structures may be provided.

In an example, the fuel cell 100 may be configured to include said fuel storage material but only operate in the redox mode. Thus, in one or more examples, only said catalyst(s) that act to promote said redox reaction may be provided. In a further example, the one or more first catalysts may not be provided and the one or more second catalysts may be provided. In such an example, the fuel storage material of the second electrode 103 may be “recharged” from an external fuel source rather than by operation in the regenerative mode. Thus, during “recharging”, gaseous hydrogen may be provided to the second electrode 105 via the flow channels of the second plate 105 and the one or more second catalyst layers 117, 116 may provide for reduction of said gaseous hydrogen to protons for storage in the fuel storage material.

In a further example, the fuel cell 100 may be configured to include said fuel storage material but only operate in the redox mode. It will be appreciated that the first and second catalyst layers act to improve the reaction rate of the fuel cell, but in some application, this may not be required. Thus, in one or more examples, the fuel cell 100 may include said fuel storage material but not one or more of said first and second catalyst layers 114, 115, 116, 117.

In a further example, the fuel cell 100 may be configured to only operate in the regenerative mode. Thus, the one or more first catalyst layers 114 may be provided but the one or more second catalyst layers 116, 117 may be absent.

Some of the specific materials that may be used in the fuel cell are described in more detail below.

### (N-Doped) Carbon Nanofoam Material

The present disclosure provides an (N-doped) carbon nanofoam material having excellent properties as a component in composite materials and fuel storage materials in fuel cells.

As used herein, the term “(N-doped)” (i.e. with parenthesis) means the material is optionally N-doped. Thus, “(N-doped) carbon nanofoam material” denotes a carbon nanofoam material that may optionally be N-doped.

As used herein, “C_{nf}” may be used to denote a carbon nanofoam material.

As used herein, “C_{nf}—Nₓ” may be used to denote an N-doped carbon nanofoam material.

Carbon materials provide useful electrocatalysts due to their high surface area, high conductivity and cost. Various types of carbon materials suitable for use as electrocatalysts are disclosed in X. Wang et al., Adv. Energy Mater., 2017, 7, 1700544.

Non-metal atoms such as N, P, S and B can be doped into the carbon structure, resulting in multiple possible configurations of doped carbon material. Being more electronegative than carbon, these heteroatoms make neighbouring carbon atoms electron deficient, thereby promoting oxygen adsorption on the carbon nanostructure. Doped carbon structures may take various forms, including nanotubes, sheets or particulate carbon materials.

Of these doping atoms, N is advantageous as it provides a stable material having the desired balance of properties. Furthermore, N-doping increases the hydrogen storage properties of a fuel storage material comprising a carbon nanofoam of the disclosure. In contrast, doping with S and P typically acidifies the carbon leading to a material with higher pH sensitivity.

The (N-doped) carbon nanofoam material of the present disclosure may be characterised as a scaffold of coalesced (N-doped) carbon nanofoam particles, said particles having a diameter of from 0.005 μm to 25 μm.

Preferably, the nanofoam particles are from 0.01 to 15 μm, preferably from 0.01 to 5 μm, more preferably from 0.01 to 2 μmin diameter.

The diameters of the nanofoam particles may be measured by SEM. Typically, in such a process the largest dimension of the particle is measured.

The average diameter may be calculated by taking the mean value of the measurement of the largest dimension of ten separate nanofoam particles.

The (N-doped) carbon nanofoam material of the disclosure is a continuous, or semi-continuous, interconnected superstructure of coalesced (N-doped) carbon nanofoam particles. This superstructure may act as a scaffold or support for the N-doped graphitic carbon in the composite material of the disclosure.

In an example, the scaffold has a tortuous path of open pores at least 3 times the average diameter of the nanofoam particles, preferably at least 5 times the average diameter of the nanofoam particles, for instance from 5 to 100 times, preferably from 5 to 50 times the average diameter of the nanofoam particles.

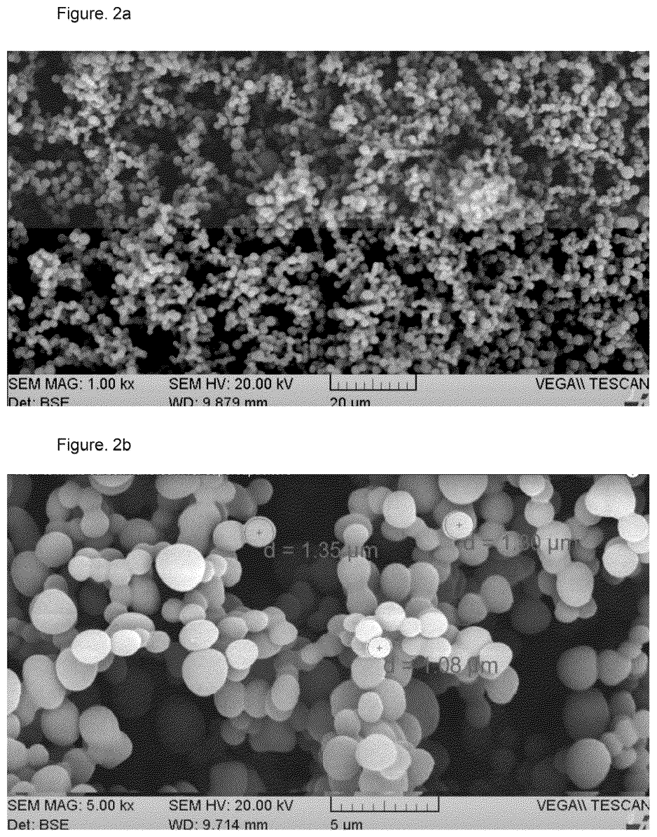

The open pores typically have an irregular shape, as shown in FIG. 2b. The pore size can be determined by SEM, with the average size of any given pore being defined as the mean of the largest and smallest dimension of that pore as determined by SEM.

The average size of the pores of the scaffold will vary depending on the size of the particles of the nanofoam particles, and are typically from 10 to 100 μm, such as for nanofoam particles being around 1 μm.

In an alternative embodiment, the average size of the pores of the scaffold are typically from 0.2 to 2 μm.

The mean pore size can be determined by the mean of 10 average pore sizes, as determined by SEM.

In an example, the (N-doped) carbon nanofoam material has a density of below 300 mg/cm³, typically from 50 to 200 mg/cm³ and preferably from 50 to 150 mg/cm³.

The density of the (N-doped) carbon nanofoam material may be measured by weighing the bulk material and then correlating for the mass of the average element density.

Methods for making carbon nanofoams are known in the art, for instance in Sattler et al., Carbon 95 (2015), pp434-441.

An example method of forming an (N-doped) carbon nanofoam material comprises:
i. forming a mixture of sugar, water and hydrocarbon mediator;
ii. heating said mixture to form a carbon nanofoam; and
iii. optionally heating the carbon nanofoam in the presence of an acidic nitrogen source (e.g. nitric acid) to form an N-doped carbon nanofoam.

Suitable sugars to use include monosaccharides, disaccharides and trisaccharides, for instance sucrose, glucose or fructose, with sucrose being preferred.

The mixture of sugar and water is highly concentrated, namely at least 3 molar, typically at least 4 molar such as about 5 molar. Such high concentrations will typically require heating and vigorous stirring to fully dissolve the sugar, typically from 50° C. to 85° C., for instance from 60° C. to 80° C.

Typically, the concentrated sugar solution is cooled before the hydrocarbon mediator is added, for instance cooled to below 50° C.

Suitable hydrocarbon mediators include aromatic hydrocarbons such as pyrene, chrysene, benz[a]anthracene, fluoranthene, anthracene, naphthalene, benzene and hexane, with anthracene, naphthalene and benzene being preferred and naphthalene being most preferred.

Typically, only a small amount of hydrocarbon mediator (e.g., naphthalene) is required. For instance, the ratio of hydrocarbon mediator (e.g., naphthalene) to sugar (e.g., sucrose) is typically from 1:25,000 to 1:75,000, or 1:50,000 to 1:65,000.

Step ii requires heating the mixture to form a nanofoam. The mixture is heated at a temperature and for a time sufficient to carbonise the sugar to form a particulate material.

Suitably, the mixture is heated at a temperature of from 100° C. to 600° C. for 30 minutes to 24 hours. Heating to a higher temperature usually requires a shorter heating time. For instance, the mixture may be heated to 500° C. for 1 hour. Alternatively, the mixture may be heated to 155° C. for 5 hours. Heating the mixture for longer is of course possible, but this is usually not required.

Preferably, the mixture is heated at a temperature of from 350° C. to 600° C. for 30 minutes to 3 hours. Alternatively, the mixture is heated at a temperature of from 100° C. to 300° C. for 4 hours to 12 hours.

The heating step carbonises the material to form a nanofoam. As such, the heating is typically carried out in a suitably inert vessel, for instance a Teflon coated hydrothermal reactor.

The heating step is preferably carried out in a sealed reactor.

The resultant nanofoam may optionally be comminuted, for instance by milling. Milling may be carried out in a ball mill.

The resultant material is a scaffold of coalesced (N-doped) carbon nanofoam particles. The (N-doped) carbon nanofoam particles are typically mesoporous, i.e., having pores of 2 nm to 50 nm. The nanofoam particles are bound together by covalent interactions, resulting in a scaffold that is surprisingly retained even under mechanical stresses such as during milling.

The pore size of the mesopores may be determined by tunnelling electron microscopy. In such a process, the material may be coated with a metal such as titanium by sputtering. After coating, the pore structure can be observed using a tunnelling electron microscope, with the pore size being determinable from the image produced. Although the methodology provides an image of the surface, it is evident from the bulk reactivity of the material that the pores extend beneath the surface into the structure of the carbon. The material is therefore best described as a mesoporous (N-doped) carbon nanofoam.

The nanofoam particles may vary in shape, and the shape can be dependent on the sugar and hydrocarbon mediator that are used. For instance, glucose and naphthalene form cube-like structures.

Sucrose and naphthalene are preferred and give rise to approximately spherical particles.

The nanofoam particles are typically from 0.01 to 15 μm, preferably from 0.01 to 5 μm, more preferably from 0.01 to 2 μm in diameter.

Step iii. comprises N-doping by heating the carbon nanofoam with an acidic nitrogen source, such as nitric acid (HNO₃), nitrous acid (HNO), hyponitrous acid (H₂N₂O), or mixtures thereof, with nitric acid being preferred.

Typically, the carbon nanofoam is heated to at least 80° C. for at least 2 hours, for instance to at least 90° C. for at least 4 hours, preferably 95° C. to 115° C. for at least 4 hours.

The heating is typically carried out in a suitable acid resistant pressure vessel, for instance a Teflon hydrothermal reactor.

The acidic nitrogen source (e.g. nitric acid) should be sufficiently concentrated to ensure sufficient levels of N-doping. Suitable concentrations (e.g. of nitric acid) include from 3 molar to 10 molar, preferably from 4 molar to 8 molar.

Treatment of the carbon nanofoam particles with nitric acid or an alternative acidic nitrogen source introduces N-doping into the structure, forming a mixture of pyridinic-N, pyrrolic-N and graphitic-N sites. However, when nitric acid, or an alternative acidic nitrogen source, is used, the acid conditions additionally form carboxylate groups at the surface of the material. Moreover, pitting of the surface can occur, resulting in loss of some of the mesoporous structure. The conditions therefore need to be controlled to provide the desired amount of doping while avoiding too much degradation of the mesoporous structure. The process is however mild enough to ensure that the scaffold of coalesced particles is retained.

Typically, the surface pore sizes are around 2 to 10% larger after treatment with nitric acid, or alternative acidic nitrogen source.

Typically, the N content of the resultant material is from 0.1 to 8 wt %, for example from 0.5 to 6 wt %, or from 1 to 5 wt %. Preferably the N content of the resultant material is 2 wt % or more.

The surface area of the resultant material is typically from 200 to 3500 m²/g, preferably 400 to 3000 m²/g, preferably 800 to 2500 m²/g, preferably 800-2000 m²/g. For example, 900 to 2000 m²/g, preferably 900 to 1500 m²/g.

The surface area may be measured by BET isotherm, for instance at 77 K using nitrogen.

The above process is an exemplary way of forming the N-doped carbon nanofoam. Alternative methods are possible. For instance, the mesoporous structure is obtained by heating the mixture of sugar, water and hydrocarbon mediator. If a nitrogen source is included in the mixture, this can lead to an N-doped carbon nanofoam being formed without the need for step iii (treatment with the acidic nitrogen source).

### Composite Material

The disclosure additionally provides a composite material comprising a superstructure of composite particles, wherein said superstructure comprises a scaffold of coalesced (N-doped) carbon nanofoam particles and a coating on the scaffold, said coating comprising N-doped graphitic carbon. The scaffold of coalesced (N-doped) carbon nanofoam particles is as described above, and may optionally themselves be N-doped, for instance as formed by treatment with an acidic nitrogen source such as nitric acid.

The N-doped graphitic carbon coating may be formed by treating the scaffold of coalesced nanofoam particles with a structural protein to coat the scaffold of (N-doped) carbon nanofoam with an N-doped graphitic carbon. This step can be carried out on a scaffold of (N-doped) carbon nanofoam particles (e.g. as formed following treatment with an acidic nitrogen source), or on the scaffold of coalesced (N-doped) carbon nanofoam particles (i.e. without N-doped the scaffold material).

During formation, the scaffold of (N-doped) carbon nanofoam provides a template for growth of the N-doped graphitic phase. The N-doped graphitic phase is typically located on the surface of the (N-doped) carbon nanofoam scaffold, for example on the external surfaces and internal surfaces, such as within the open pores.

The composite material typically retains the same overall structure as the coalesced particles of (N-doped) carbon nanofoam scaffold used as the template prior to coating with N-doped graphitic carbon phase.

Consequently, the composite material may be described as comprising composite particles.

The composite particles therefore comprise a continuous, or semi-continuous, scaffold of (N-doped) carbon nanofoam that is coated with N-doped graphitic carbon. The N-doped graphitic phase is typically located on the surface of the (N-doped) carbon nanofoam scaffold, for example on the external surfaces and internal surfaces, such as within the open pores.

The composite particles are coalesced via the (N-doped) carbon nanofoam scaffold to form the composite material superstructure. That is, the (N-doped) carbon nanofoam scaffold interconnects the composite particles to form a superstructure.

The coalesced superstructure of composite particles may also comprise N-doped graphitic carbon on the available surfaces.

In the context of this disclosure, “N-doped graphitic carbon” means graphite-like carbon which contains nitrogen atoms in the graphitic plane. Such nitrogen atoms form graphitic (i.e. replacing a carbon and having three bonds), pyridinic (i.e. replacing a carbon and having two bonds, forming a six membered ring), and pyrrolic sites (i.e. replacing a carbon and having two bonds, forming a five membered ring) within the graphitic plane. Pyridinic and pyrrolic sites within the graphitic plane cause defects or open sites within the plane, owing to the reduced number of atoms.

Preferably, the composite particles are from 0.005 μm to 25 μm in diameter. For example, the composite particles are from 0.01 to 15 μm, for instance from 0.01 to 5 μm, or from 0.01 to 2 μm in diameter.

Smaller particles have a much higher surface area and are typically preferred.

Preferably, the composite particles have a diameter of 100 nm or less, such as 50 nm or less, or 30 nm or less, for instance 25 nm or less, or 20 nm or less. Preferably the composite particles have a diameter of 10 to 30 nm.

The composite particles tend to aggregate and form clusters. Typically, the clusters have a diameter of from 1 to 10 μm, for instance from 2 to 8 μm, or 3 to 6 μm.

For instance, when the composite particles are around 20 nm, the aggregate clusters may have a diameter of around 3 to 6 μm.

The diameters of the composite particles and clusters may be measured by TEM. Typically, in such a process the largest dimension of the particle/cluster is measured.

Formation of the composite material typically involves:
heating the (N-doped) carbon nanofoam material with a structural protein in a reduced oxygen environment.

Thus, an example method of forming the composite material comprises:
a. forming a mixture of sugar, water and hydrocarbon mediator;
b. heating the mixture to form a carbon nanofoam material;
c. optionally heating the carbon nanofoam in an acidic nitrogen source (e.g. nitric acid) to form an N-doped carbon nanofoam;
d. optionally comminuting the (N-doped) carbon nanofoam material;
e. heating the (N-doped) carbon nanofoam material with a structural protein in a reduced oxygen environment to form a composite material;
f. optionally treating the composite material with a pitting agent to form an activated composite material; and
g. optionally comminuting the composite material.

Steps e. to g. may be repeated as necessary until the required amount of N-doped graphitic regions are obtained, and the required active surface area is achieved.

Steps a., b. and c. are identical to step i., ii., and iii. of the example method for forming the (N-doped) carbon nanofoam material.

Step d. is optional but often done to ensure a more consistent material is used as the scaffold for the formation of N-doped graphitic carbon. Suitable comminuting methods include milling, for instance ball milling.

Step e. involves heating the resultant nanofoam with a structural protein in a reduced oxygen environment to form a N-doped graphitic coating on the (N-doped) carbon nanofoam.

The reduced oxygen environment can be achieved by any means, although it is preferred to use an inert atmosphere (such as argon gas) or vacuum.

The mixture is heated to a high temperature for a relatively short period. Prolonged heating at the temperatures required to effect N-doping is possible, though usually not necessary.

Typically, step e. involves heating at a temperature of at least 400° C. for at least 10 minutes, for instance from 450° C. to 900° C. from 10 minutes to 3 hours, preferably from 500 to 600° C. from 30 minutes to 90 minutes.

Heating at a higher temperature such as over 1000° C. will graphitize the structural protein, leading to formation of large volumes of graphite. The temperatures used in step e. involve a lower temperature, resulting in partial graphitisation.

The resultant material contains N-doped graphitic carbon coated over the (N-doped) carbon nanofoam, for example on the external surfaces and internal surfaces, such as within the open pores.

Optional step f, involves treating the resultant material with a pitting agent to form an activated composite material. In the context of the disclosure, a “pitting agent” refers to a substance that causes activation of the composite material by e.g., increasing the surface area. For instance, step f. may create pits or indentations in the surface of the composite material, providing a larger active surface area.

A composite material that has been pitted may be described as an “activated composite material”.

Suitable pitting agents include alkali or alkaline earth carbonate, alkali or alkaline earth hydroxide, such as NaOH, KOH, Na₂CO₃, K₂CO₃, or mixtures thereof.

Alternatively, acidic pitting agents such as H₂SO₄, HCl, HNO₃H₃PO₄ and mixtures thereof may be used.

Preferably, the pitting agent is an alkali or alkaline earth carbonate. When an alkali or alkaline earth carbonate pitting agent is used, regular, consistent pitting is achieved. Typically, alkali or alkaline earth carbonate pitting agents increase the number of mesopores within the material, wherein the mesopores have smooth or rounded edges. Rounded mesopores are particularly advantageous for hydrogen storage via physisorption.

In contrast, when an acidic pitting agent is used, the pitting is more random and the newly formed indentations may have jagged edges have an irregular shape.

Preferably, the pitting agent is K₂CO₃.

The pitting agent should be included in an amount sufficient to increase the activate the surface, which typically required the pitting agent to be in (weight) excess. For example, the weight ratio of composite material to pitting agent may be 1:1.5 or more, for instance, 1:2 to 1:10, 1:2.5 to 1:8, or 1:3 to 1:5. Preferably the weight ratio of composite material:pitting agent is 1:3.

Step f. should be carried out in a reduced oxygen environment, at high temperature. Typically, step f. is be carried out at a temperature of at least 600° C. for at least 10 minutes, for instance, 650-1000° C. for 10 minutes to 3 hours, preferably from 750-850° C. for 1 hour.

The optional step g. may be carried out by milling. This step results in any loosely bound graphitic materials breaking away to leave a superstructure of composite particles comprising a scaffold of coalesced (N-doped) carbon nanofoam and a coating of N-doped graphitic.

The N-doped graphitic material is preferably covalently bound to the scaffold.

Typically, the N content of the resultant material is from 0.1 to 8 wt %, for example from 0.5 to 6 wt %, or from 1 to 5 wt %. Preferably the N content of the resultant material is 2 wt % or more.

The surface area of the resultant material is typically from 200 to 3500 m²/g, preferably 400 to 3000 m²/g, preferably 800 to 2500 m²/g, preferably 800-2000 m²/g. For example, 900 to 2000 m²/g, preferably 900 to 1500 m²/g.

When a pitting agent is used, the surface area of the resultant material may be from 25% to 50% higher than for the same material before pitting. The amount by which the surface area is increased will depend on the volume/concentration of pitting agent, the temperature at which pitting is carried out, the length of the pitting step, and the type of pitting agent used.

Any suitable structural protein may be used, such as keratin or collagen, with keratin being preferred. The structural protein should preferably be dried and in a form to allow intimate mixing with the carbon particles, such as in a powdered form.

Suitable collagen materials that can be used include gelatine.

Any source of keratin may be used, including hair, nails, feathers, horns, claws, baleen or hooves.

Preferably, the structural protein is avian feathers. Avian features are highly porous and it has been found that the resultant material retains porosity after carbonisation to form the N-doped graphitic coating.

Any suitable avian features can be used, with farmed birds such as chicken, turkey, duck and goose being particularly suitable due to their availability.

Down feathers are preferred, particularly goose down and duck down.

Typically, the avian feathers are mixed with the (N-doped) carbon nanofoam in a weight ratio of 2:1 to 1:4 of nanofoam to feathers, preferably a weight ratio 3:2 to 1:3.

Following formation of the coating layer, the resultant material can optionally be comminuted, for instance by milling.

### OER, ORR, HER, HRR Catalytic Materials

Various types of catalytic materials are known for use in fuel cells. For instance, X. Wang et al., Adv. Energy Mater., 2017, 7, 1700544 and C. Zhang et al., Front. Energy., 2017, 11, 268-285 and N. Alonso-Vante et al., catalysts, 2018, 8, 559 provide an overview.

In some embodiments, a bifunctional catalyst may be used in the fuel cell. Bifunctional catalysts are catalysts that have the ability to catalyse two different types of reactions.

In some instances, the ORR and the OER may be catalysed by the same bifunctional catalyst.

In some instances, the OER and HER may be catalysed by the same bifunctional catalyst.

In instances where a bifunctional catalyst is used, a heterojunction may be employed to separate the positive and negative charges in an organic material.

Noble metal-based electrocatalysts (Pt, Ir and Ru-based) are well-known to catalyse ORR, OER and HER reactions.

Platinum group metals are known for use as electrocatalysts and the most commonly used in electrocatalysis platinum. However, due to concerns with durability platinum usage worldwide, research has been done into new platinum group metal alloy nanoparticles supported on a conductive substrate, such as, carbon, carbon black, oxides, single-walled carbon nanotubes and carbon nanofibers.

Such platinum group metal alloys can be described as Pt-M (wherein M=3d transition metal) alloy nanoparticles. For example, wherein M is one or more of Ni, Co, Fe, Cu, Pd, Rh, Ti, V, Cr, Mo, W and Re. For example, PtNi₃, PtxCo (wherein x=2, 3, 5, 7 and 9), Pt₃Cu, PtCu and PtCu₃.

In some instances, ternary Pt-based systems may also be suitable catalysts. For example, catalysts that may be described as Pt-M-N, wherein M is as defined as above and Nis Fe, Cu, Ni or Co. For instance, Pt₂CuNi, Pt₃CoNi, Pt₃FeNi and Pt₃FeCo.

Transition metal-based catalysts are also known as suitable electrocatalysts for ORR, OER and HER. For example, Ti, V, Mn, Fe, Ru, Co, Rh, Ir, Ni, Pd, Pt, or mixtures thereof based catalysts such as Mn, Co, Ni and Fe oxides.

Preferably, the transition metal is selected from Co, Fe, Ni, or mixtures thereof.

Preferably, the transition metal is Co.

Suitable cobalt based catalysts include, but are not limited to, cobalt oxide, cobalt phosphides, cobalt halides, cobalt nitrates, cobalt chalcogenides (sulphide and selenides), Co-included layered double hydroxides, Co—N—C, Co-based single atoms, Co-MOFs (metal organic frameworks), cobalt carboxylates, Co-Nx/C and their composites.

### Fuel Storage Material

The disclosure additionally provides a fuel storage material that finds particular use in fuel cells, said fuel storage material comprising a proton conducting polymeric material and composite material comprising a superstructure of composite particles, wherein said superstructure comprises:
a scaffold of coalesced (N-doped) carbon nanofoam particles; and
a coating on the scaffold, said coating comprising N-doped graphitic carbon.

The (N-doped) carbon nanofoam material coated with N-doped graphitic carbon is preferably as set out herein.

The proton conducting polymeric material is typically capable of conducting protons at room temperature, i.e., at 25° C.

By “capable of conducting protons” is meant a proton conductivity of greater than 10-3 S/cm, preferably greater than 10-2 S/cm. Of course, the polymer itself may have very poor proton conductivity in its dry form. The proton conductivity of the polymeric material is measured on the hydrated and (if necessary) acidified polymer.

The proton conducting polymeric material may be an acid doped hydrogel.

When a hydrogel is doped with a suitable acid, such as phosphoric acid or sulphuric acid, the resultant polymeric material displays very high proton conductivity.

Suitable levels of acid dopant in the hydrogel are from 5 to 25 wt %, preferably from 10 to 20 wt %.

Suitable hydrogels are selected from polyvinyl alcohol, poly(meth)acrylate, collagen, gelatine and fibrin.

Preferred hydrogel polymers are selected from poly(meth)acrylate and gelatine, with polyacrylate being particularly preferred.

The fuel storage material typically contains less than 15 wt % acid doped hydrogel, preferably from 0.1 to 12 wt %, more preferably from 0.2 to 10 wt %, more preferably from 0.5 to 8 wt %.

The proton conducting polymeric material may be a fluorinated acid polymer, preferably a fluorinated acid polymer as set out herein.

Preferably, the fluorinated acid polymer in the fuel storage material has Formula X:

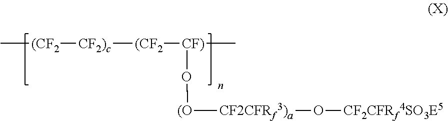

where
each c is independently 0 or an integer from 1 to 3;
n is at least 4;
R_{f}³ and R_{f}⁴ are independently selected from F, Cl or a highly-fluorinated alkyl group having 1 to 10 carbon atoms,
a=0, 1 or 2, and
E⁵ is selected from hydrogen or a cation such as Li, Na, or K.

Preferably the fluorinated acid polymer in the fuel storage material comprises a perfluorocarbon backbone and the side chain represented by the formula

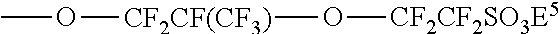

where
E⁵ is selected from hydrogen or a cation such as Li, Na, or K.

Preferably, the fluorinated acid polymer in the fuel storage material has formula XI:

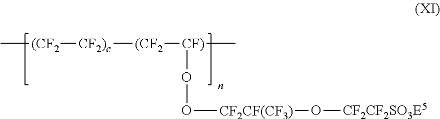

where
each c is independently 0 or an integer from 1 to 3;
n is at least 4; and
E⁵ is selected from hydrogen or a cation such as Li, Na, or K.

The fuel storage material typically contains less than 5 wt % fluorinated acid polymer, for instance from 0.05 to 5 wt %, preferably from 0.1 to 4 wt %, more preferably from 0.1 to 3 wt %, more preferably from 0.2 to 2 wt %.

In an example, a method of making the fuel storage material comprises:
forming a paste of composite material, proton conducting polymeric material and a dispersing agent, said composite material comprising
a superstructure of composite particles, wherein said superstructure comprises a scaffold of coalesced (N-doped) carbon nanofoam particles and a coating on the scaffold, said coating comprising N-doped graphitic carbon;
pressing the paste into a compacted form; and
drying the compacted form.

Typically, the paste is formed using water as the dispersing agent.

When the proton conducting polymeric material is an acid doped hydrogel, the forming step may comprise:
forming a mixture of hydrogel-forming polymer, acid dopant and composite material;
lyophilising the mixture; and
adding water for form a paste of lyophilised conducting polymeric material and composite material.

The lyophilising step increases the structural integrity of the hydrogel, allowing it to retain better proton conductivity when incorporated into the fuel storage material.

Typically, the drying step involves heating the compacted form at a temperature high enough to facilitate removal of the dispersing agent, but low enough not to damage the proton conducting polymeric material.

Suitable temperatures include from 50 to 250° C., such as from 100 to 200° C. when fluorinated acid polymer is used as the proton conducting material. The heating may be carried out in a flowing air stream to facilitate removal of the dispersing agent.

When acid doped hydrogel is used as the proton conducting material, it is usually preferred to avoid heating to a high temperature during the drying step, as these hydrogels tend to be less stable at higher temperatures. Preferably, the drying step comprises drying at a temperature no higher than 75° C.

Optionally, after drying the material may be degassed, for instance in a vacuum furnace.

The fuel storage material may additionally comprise an Arrhenius acid to facilitate uptake and storage of protons. Any Arrhenius acid may be used, with suitable acids including sulphuric acid, phosphoric acid, and nitric acid. The Arrhenius acid added to the fuel cell may also be called an “polymer activating agent”.

For hydrogel-based proton conducting materials, the acid is preferably phosphoric acid.

For fluorinated polymeric sulfonic acid-based proton conducting materials, the acid is preferably sulphuric acid.

The material may be loaded with Arrhenius acid by soaking in a solution of the acid for a sufficient period (e.g., for at least 4 hours).

Once loaded with the acid, the material can be dried to remove most of the water, however it is beneficial to retain a low degree of hydration to ensure sufficient proton conductivity. Residual water within the material aids in transport and retention of hydrogen ions, which interact with the water to form hydronium ions.

Typically, the fuel storage material contains at least 0.01 wt % water, preferably at least 0.1 wt % water, for instance from 0.01 to 5 wt % water, preferably from 0.1 to 2 wt % water.

Without wishing to be bound by theory, the N-doped graphitic carbon phase facilitates chemisorption of hydronium ions within the fuel storage material, with the nitrogen sites (particularly the pyridinic and pyrrolic sites) able to hydrogen bond to the ions immobilising them on the surface of the material.

By “hydronium ion” is meant protonated water, i.e. H₃O⁺. The fuel storage material of the disclosure may store hydronium itself, or solvated forms of hydronium such as H₅O₂⁺, H₇O₃⁺, H₉O₄⁺, or mixtures thereof.

Charge balance is believed to be achieved by the negative charge being stored in the graphitic material, which is further facilitated and stabilised by the electronegativity of the nitrogen atoms and overall high conductivity of the material.

In the operating fuel cell, the released hydronium ions migrate to the PEM, with the protons passing through the PEM to the counter electrode where they react with oxygen to form water.

Without wishing to be bound by theory, the fuel storage material also stores hydrogen via physisorption within the mesopores of the (N-doped) carbon nanofoam. Thus, when the concentration of hydronium ions increases, it becomes less preferable to store additional hydrogen as hydronium with the charge balance residing within the graphitic material. Instead, dihydrogen is formed, and once the pressure increases to a sufficient level (for instance above about 5 bar), this condenses inside the mesopores of the (N-doped) carbon nanofoam. Inside the mesopores, the hydrogen is in a pseudo-liquid state. The liquified hydrogen is affixed to the fuel storage material by physical adsorption to the surfaces of mesopores. Typically, liquification of hydrogen occurs at high pressures (e.g. 300 bar), however, confinement liquification occurs within the mesopores of the (N-doped) carbon nanofoam, which facilitates liquification at a much lower pressure (e.g., around 5 bar).

N-doping of the carbon nanofoam further promotes physisorption due to the electronegativity of the N atoms promoting the formation of van der Waals interactions between the hydrogen and the N-doped carbon nanofoam. In order to increase hydrogen storage properties of the fuel storage material, an increase in the number of mesopores within the carbon nanofoam is beneficial, as well as increasing the degree of N-doping.

The dominant hydrogen storage mechanism within the fuel storage material depends on the temperature and pressure of the system. Typically, chemisorption dominates at pressures below 5 bar, and typically temperature below 80° C., and physisorption dominates at pressure of 5 bar and above, and typically at temperatures of 80° C. and above. However, it is common that hydrogen is stored via both chemisorption and physisorption simultaneously.

Surprisingly, the fuel storage material is capable of storing hydrogen at levels of above 1 wt %, for instance above 1.5 wt %, or above 1.8 wt %, or even above 2 wt %.

### Protocols for Measurements

### Calculation of Pore Size

To calculate pore diameters of micropore levels and smaller, the inventors have used the protocol set out in Kawazoe et al., J. Chem. Eng. Japan, 16 (6), 1983, 470-475.

The above protocol describes a method for the calculation of effective pore size distribution from adsorption isotherms. Calculation of the pore size distribution was done from N₂ isotherms at 77 K.

For measurement of the N₂ isotherms at liquid N₂ temperature a sample (~0.3 g) was put into a sample holder and degassed at 200° C. and 10⁻⁵ Torr (1.33×10⁻³ Pa) pressure for at least 48 hours. A Cahn electrobalance provided highly accurate mass measurement. For the measurement of pressure ULVAC ionization vacuum gauges and MKS Baratron sensors were used (pressure ranges 1.33×10⁻⁶-6.65×10⁻¹ Pa; 1.33×10⁻¹-10⁵ Pa).

To calculate pore volumes greater than 1.5 nm, the inventors have used the following protocol: Dollimore, D. and G. R. Heal et al., J. Appl. Chem., 14, 1964, 109-114.

The above protocol describes a method for calculating the pore size distribution from adsorption isotherms on porous solids.

Herein, the total amount of nitrogen taken up at a pressure of 1 atmosphere and a temperature of 77K gave the total pore volume. With the model of cylindrical pores the total pore volume was calculated using:

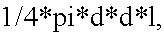

where
d is the mean pore diameter and
l is the total length of the pores.

If the BET surface area measured the total surface area of the pores, the BET surface area S(BET)=pi*d*l. From the two equations 1 was eliminated and the average diameter d was calculated.

The Barrett-Joiner-Halenda (BJH) procedure assumes capillary condensation of the liquid nitrogen within the pores and calculates from the relative pressures and the amount of nitrogen taken up at a given relative pressure of the sorption isotherm taking into account the adsorbed layer of nitrogen and the capillary condensed nitrogen the pore size distribution. The adsorption and the desorption branch lead to different pore size distributions. Therefore, the desorption branch was usually employed.

### Surface Area

Samples were treated at elevated temperatures (120° C.) and reduced pressures for at least 8 hours before nitrogen sorption to remove any bound gases and adsorbed water from the materials.

The N₂ sorption analysis may be performed using a Belsorp Mini (Bel Japan, Inc.) apparatus at 77K, using liquid gas for each respective test, and surface areas calculated using the Brunauer-Emmett-Teller (BET) theory using sorption data.

### Calculation of Density for Carbon Nanofoams

The following methods were used:

Displacement density method: using water as the displacement medium, density is calculated at 22° C., 1 atm of pressure and using the equation D=m/v (mass divided by volume).

TAP density method, as described by:
The International Pharmacopoeia, s.3.6. Bulk Density and Tapped Density of Powders, QAS11_450 FINAL (modified March 2012). The tapped density is an increased bulk density attained after mechanically tapping a container containing the powder sample.
Here, the tapped density is obtained by mechanically tapping a graduated cylinder containing the sample until little further volume change is observed. The tapping can be performed using different methods. The tapped density is calculated as mass divided by the final volume of the powder.
A mean average was subsequently taken of the two measurement methodologies.

### Conductivity of the Pulverized Material Samples

Spin coating was used to prepare the material samples. The material samples were prepared in the same manner as the preparation steps for making electrodes. Namely, a silver foil in a solution containing the material samples and a 5% addition of binder.

If the resistance of the material samples was of a magnitude of kiloohms or more, a two-point probe was used.

The spin coated film is mounted in a metallic sample holder and a vacuum is created inside to get rid of moisture.

2-Point and 4-Point probe tests may be used.

The conductivity of the samples that was measured was on average 0.4 S/cm to 100 S/cm depending on layer thickness and conductivity of the carbon support utilized.

Preferences, options and embodiments for a given aspect, feature or parameter of the invention should, unless the context indicates otherwise, be regarded as having been disclosed in combination with any and all preferences, options and embodiments for all other aspects, features and parameters of the invention. Embodiments and features of the present invention are also outlined in the following items.

A1. An (N-doped) carbon nanofoam material comprising a scaffold of coalesced (N-doped) carbon nanofoam particles, preferably wherein said particles have a diameter of from 0.005 μm to 25 μm.

A2. (N-doped) carbon nanofoam material according to item A1, wherein the (N-doped) carbon nanofoam particles have a diameter of from 0.01 to 15 μm.

A3. (N-doped) carbon nanofoam material according to item A1 or A2, wherein the (N-doped) carbon nanofoam particles have a diameter of from 0.01 to 5 μm.

A4. (N-doped) carbon nanofoam material according to any one of items A1-A3, wherein the (N-doped) carbon nanofoam particles have a diameter of from 0.01 to 2 μm.

A5. (N-doped) carbon nanofoam material according to any one of items A1-A4, wherein the (N-doped) carbon nanofoam particles are mesoporous.

A6. (N-doped) carbon nanofoam material according to any one of items A1-A5, wherein the material is a scaffold of coalesced (N-doped) carbon nanofoam particles, said scaffold having a tortuous path of open pores at least 3 times the average diameter of the nanofoam particles.

A7. (N-doped) carbon nanofoam material according to any one of items A1-A6, wherein the open pores of the scaffold have a mean pore size of 10 to 100 μm.

A8. (N-doped) carbon nanofoam material according to item A7, wherein the open pores of the scaffold have a mean pore size of 0.2 to 2 μm.

A9. (N-doped) carbon nanofoam material according to any one of items A1-A8, wherein the material has a density of below 300 mg/cm³.

A10. (N-doped) carbon nanofoam material according to item A9, wherein the material has a density of 50 to 200 mg/cm³.

A11. (N-doped) carbon nanofoam material according to item A10, wherein the material has a density of 50 to 150 mg/cm³.

A12. An (N-doped) carbon nanofoam material according to any one of items A1-A11, wherein the (N-doped) carbon nanofoam has an N content of from 0.1 to 8 wt %.

A13. An (N-doped) carbon nanofoam material according to any one of items A1-A12, wherein the (N-doped) carbon nanofoam has an N content of from 1 to 5 wt %.

A14. An (N-doped) carbon nanofoam material according to any one of items A1-A13, wherein the (N-doped) carbon nanofoam has an N content of 2 wt % or more.

A15. An (N-doped) carbon nanofoam material according to any one of items A1-A14, wherein the (N-doped) carbon nanofoam has a surface area of from 400 to 3000 m²/g.

A16. An (N-doped) carbon nanofoam material according to any one of items A1-A14, wherein the (N-doped) carbon nanofoam has a surface area of from 900 to 2000 m²/g.

A17. An (N-doped) carbon nanofoam material according to any one of items A1-A14, wherein the (N-doped) carbon nanofoam material has a surface area of from 900 to 1500 m²/g.

A18. An (N-doped) carbon nanofoam material according to any one of items A1-A17, wherein the (N-doped) carbon nanofoam is an N-doped carbon nanofoam material.

B1. A method of forming an (N-doped) carbon nanofoam material comprising:
i. forming a mixture of sugar, water and hydrocarbon mediator;
ii. heating said mixture to form a carbon nanofoam; and
iii. optionally heating the carbon nanofoam in the presence of an acidic nitrogen source to form an N-doped carbon nanofoam.

B2. A method according to item B1, wherein the sugar is one or more monosaccharide, disaccharide and/or trisaccharide.

B3. A method according to item B2, wherein the sugar is one or more of sucrose, glucose or fructose.

B4. A method according to item B3, wherein the sugar is sucrose.

B5. A method according to any one of items B1-B4, wherein the solution of sugar and water is a concentration of at least 3 mol/dm³.

B6. A method according to any one of items B1-B5, wherein the solution of sugar and water is a concentration of at least 4 mol/dm³.

B7. A method according to any one of items B1-B6, wherein the solution of sugar and water is a concentration of at least 5 mol/dm³.

B8. A method according to any one of items B1-B7, wherein the solution is fully dissolved in the water to form the mixture of sugar and water.

B9. A method according to item B8, wherein the sugar is dissolved in the water by heating and stirring vigorously.

B10. A method according to item B9, wherein the sugar is dissolved in the water by heating the solution from 50° C. to 85° C.

B11. A method according to item B9, wherein the sugar is dissolved in the water by heating the solution from 60° C. to 80° C.

B12. A method according to any one of items B5-B11, wherein the solution of sugar and water is cooled before the hydrocarbon mediator is added.

B13. A method according to item B12, wherein the solution of sugar and water is cooled to below 50° C. before the hydrocarbon mediator is added.

B14. A method according to any one of items B1-B13, wherein the hydrocarbon mediator is an aromatic hydrocarbon.

B15. A method according to item B14, wherein the aromatic hydrocarbon is pyrene.

B16. A method according to item B14, wherein the aromatic hydrocarbon is chrysene.

B17. A method according to item B14, wherein the aromatic hydrocarbon is benz[a]anthracene.

B18. A method according to item B14, wherein the aromatic hydrocarbon is fluoranthene.

B19. A method according to item B14, wherein the aromatic hydrocarbon is anthracene.

B20. A method according to item B14, wherein the aromatic hydrocarbon is naphthalene.

B21. A method according to item B14, wherein the aromatic hydrocarbon is benzene.

B22. A method according to item B14, wherein the aromatic hydrocarbon is hexane.

B23. A method according to any one of items B1-B13, wherein the hydrocarbon mediator is one or more of the aromatic hydrocarbons of items B15-B22.

B24. A method according to item B1, wherein the hydrocarbon mediator is naphthalene and the sugar is sucrose.

B25. A method according to any one of items B1-B24, wherein the ratio of hydrocarbon mediator to sugar is from 1:25,000 to 1:75,000.

B26. A method according to any one of items B1-B25, wherein the ratio of hydrocarbon mediator to sugar is from 1:50,000 to 1:65,000.

B27. A method according to any one of items B1-B26, wherein step ii is carried out at a temperature and for a time sufficient to carbonise the sugar to form a particulate material.

B28. A method according to item B27, wherein step ii is carried out at a temperature from 100° C. to 600° C. for 30 minutes to 24 hours.

B29. A method according to item B28, wherein step ii is carried out at a temperature of 350° C. to 600° C. for 30 minutes to 3 hours.

B30. A method according to item B29, wherein step ii is carried out at a temperature of 100° C. to 300° C. for 4 hours to 12 hours.

B31. A method according to any one of items B1-B30, wherein step ii is carried out in an inert vessel.

B32. A method according to any one of items B1-B31, wherein step ii is carried out in a sealed reactor.

B33. A method according to any one of items B1-B32, wherein the nanofoam produced in step ii is comminuted.

B34. A method according to item B33, wherein the (N-doped) carbon nanofoam particles coalesce to form a scaffold.

B35. A method according to items B33 or B34, wherein the (N-doped) carbon nanofoam particles are mesoporous.

B36. A method according to any one of items B33-B35, wherein the carbon nanofoam particles formed in step ii are from 0.1 to 25 μm in diameter.

B37. A method according to any one of items B33-B36, wherein the carbon nanofoam particles formed in step ii are from 0.2 to 15 μm in diameter.

B38. A method according to any one of items B33-B37, wherein the carbon nanofoam particles formed in step ii are from 0.5 to 5 μm in diameter.

B39. A method according to any one of items B33-B38, wherein the carbon nanofoam particles formed in step ii are from 0.5 to 2 μm in diameter.

B40. A method according to any one of items B1-B39, wherein the carbon nanofoam in step iii is heated to at least at least 80° C. for at least 2 hours.

B41. A method according to any one of items B1-B40, wherein the carbon nanofoam in step iii is heated to at least at least 90° C. for at least 4 hours.

B42. A method according to any one of items B1-B41, wherein the carbon nanofoam in step iii is heated to between 95° C. to 115° C. for at least 4 hours.

B43. A method according to any one of items B1-B42, wherein step iii is carried out in a suitable acid resistant pressure vessel.

B44. A method according to any one of items B1-B43, wherein the acidic nitrogen source is nitric acid.

B45. A method according to item B44, wherein nitric acid used in step iii, and is at a concentration of from 3 mol/dm³ to 10 mol/dm³.

B46. A method according to item B44, wherein nitric acid is used in step iii, and is at a concentration of from 4 mol/dm³ to 8 mol/dm³.

B47. A method according to any one of items B1-B46, wherein the (N-doped) carbon nanofoam has an N content of from 0.1 to 8 wt %.

B48. A method according to any one of items B1-B47, wherein the (N-doped) carbon nanofoam has an N content of from 1 to 5 wt %.

B49. A method according to any one of item B1-B48, wherein the (N-doped) carbon nanofoam has an N content of 2 wt % or more.

B50. A method according to any one of items B1-B49, wherein the (N-doped) carbon nanofoam has a surface area of from 400 to 3000 m²/g.

B51. A method according to any one of items B1-B50, wherein the (N-doped) carbon nanofoam has a surface area of from 900 to 2000 m²/g.

B52. A method according to any one of items B1-B51, wherein the (N-doped) carbon nanofoam has a surface area of from 900 to 1500 m²/g.

B53. An (N-doped) carbon nanofoam material obtainable by the method of item B1 to B52.

C1. A composite material comprising a superstructure of composite particles, wherein said superstructure comprises:
a scaffold of coalesced (N-doped) carbon nanofoam particles; and
a coating on the scaffold, said coating comprising N-doped graphitic carbon.

C2. Composite material according to item C1, wherein the composite particles have a diameter of from 0.005 to 25 μm.

C3. Composite material according to item C1 or C2, wherein the composite particles have a diameter of from 0.01 to 15 μm in diameter.

C4. Composite material according to any one of items C1-C3, wherein the composite particles have a diameter of 0.01 to 2 μm.

C5. Composite material according to any of items C1-C4, wherein the composite particles have a diameter of 100 nm or less.

C6. Composite material according to any one of items C1-C5, wherein the composite particles have a diameter of from 10 to 30 nm.

C7. Composite material according to any one of items C1-C6, wherein the composite particles aggregate into clusters of from 1 to 10 μm.

C8. Composite material according to any one of items C1-C7, wherein the composite particles aggregate into clusters of from 2 to 8 μm.

C9. Composite material according to any one of items C1-C8, wherein the composite particles aggregate into clusters of from 3 to 6 μm.

C10. Composite material according to any one of items C1-C9, wherein the (N-doped) carbon nanofoam particles are mesoporous.

C11. Composite material according to any one of items C1-C10, wherein the (N-doped) carbon nanofoam particles are N-doped.

C12. Composite material according to any one of items C1-C11, wherein the N-doped graphitic carbon coating is formed by treating (N-doped) carbon nanofoam with a structural protein to coat the nanofoam with an N-doped graphitic carbon.

C13. Composite material according to any one of items C1-C12 wherein the material has N-doped graphitic regions that are located in the open pores of the scaffold of coalesced (N-doped) carbon nanofoam particles.

C14. Composite material according to any one of items C1 to C13, wherein the N-doped graphitic carbon is covalently bound to the (N-doped) carbon nanofoam scaffold.

C15. Composite material according to any one of items C1-C14, wherein the N content of the material is from 0.1 to 8 wt %.

C16. Composite material according to any one of items C1-C15, wherein the N content of the material is from 1 to 5 wt %.

C17. A Composite material according to any one of items C1-C16, wherein the N content of the material is 2 wt % or more.

D1. A method of making a composite material by heating a (N-doped) carbon nanofoam material (preferably a (N-doped) carbon nanofoam material as defined in any one of items A1-A18) with a structural protein in a reduced oxygen environment.

D2. A method of forming the composite material, comprising:
a. forming a mixture of sugar, water and hydrocarbon mediator;
b. heating the mixture to form a carbon nanofoam material;
c. optionally heating the carbon nanofoam in the presence of an acidic nitrogen source (such as nitric acid) to form an N-doped carbon nanofoam;
d. optionally comminuting the (N-doped) carbon nanofoam material;
e. heating the (N-doped) carbon nanofoam material with a structural protein in a reduced oxygen environment to form a composite material;
f. optionally treating the composite material with a pitting agent to form an activated composite material; and
g. optionally comminuting the material.

D3. A method according to item D2, wherein steps (e) to (g) may be repeated as necessary until the required amount of N-doped graphitic regions are obtained.

D4. A method according to item D2 or D3, wherein steps (a), (b) and (c) are identical to steps (i), (ii) and (iii) in any of items B1-B51.

D5. A method according to any one of items D2-D4, wherein comminuting steps (d) and/or (f) are done by milling.

D6. A method according to any one of items D2-D5, wherein step (e) forms an N-doped graphitic carbon covalently bound to the (N-doped) carbon nanofoam.

D7. A method according to any one of items D1-D6, wherein the reduced oxygen environment is achieved through using an inert atmosphere (such as argon gas).

D8. A method according to any one of items D1-D7, wherein the reduced oxygen environment is achieved through using a vacuum.

D9. A method according to any one of items D1-D8, wherein step the (N-doped) carbon nanofoam material is heated to a temperature of at least 400° C. for at least 10 minutes.

D10. A method according to any one of items D1-D9, wherein the (N-doped) carbon nanofoam material is heated to a temperature of at least 450° C. to 900° C. from 10 minutes to 3 hours.

D11. A method according to any one of items D1-D10, wherein the (N-doped) carbon nanofoam material is heated to a temperature of at least 500° C. to 600° C. from 30 minutes to 90 minutes.

D12. A method according to any one of items D9-D11, wherein the resultant material contains N-doped graphitic carbon.

D13. A method according to any one of items D1-D12, wherein the structural protein is dried and in a form to allow intimate mixing with the carbon particles.

D14. A method according to D13, wherein the structural protein is in powdered form.

D15. A method according to any one of items D1-D14, wherein the structural protein is collagen.

D16. A method according to item D15, wherein the source of collagen is gelatine.

D17. A method according to any one of items D1-D14, wherein the structural protein is keratin.

D18. A method according to item D17, wherein the source of keratin is from hair.

D19. A method according to item D17, wherein the source of keratin is from nails.

D20. A method according to item D17, wherein the source of keratin is from feathers.

D21. A method according to item D17, wherein the source of keratin is from horns.

D22. A method according to item D17, wherein the source of keratin is from claws.

D23. A method according to item D17, wherein the source of keratin is from baleen.

D24. A method according to item D17, wherein the source of keratin is from hooves.

D25. A method according to item D20, wherein the feathers are avian feathers.

D26. A method according to item D25, wherein the avian feathers are farmed bird feathers.

D27. A method according to item D25, wherein the avian feathers are chicken feathers.

D28. A method according to item D25, wherein the avian feathers are turkey feathers.

D29. A method according to item D25, wherein the avian feathers are duck feathers.

D30. A method according to item D25, wherein the avian feathers are goose feathers.

D31. A method according to item D25, wherein the avian feathers are down feathers.

D32. A method according to item D31, wherein the down feathers are goose down feathers.

D33. A method according to item D31, wherein the down feathers are duck down feathers.

D34. A method according to any one of items D25-D33, wherein the ratio of avian feathers to (N-doped) carbon nanofoam is in a weight ratio of 2:1 to 1:4 of nanofoam to feathers.

D35. A method according to any one of items D25-D33, wherein the ratio of avian feathers to (N-doped) carbon nanofoam is in a weight ratio of 3:2 to 1:3 of nanofoam to feathers.

D36. A method according to any one of items D1-D35, wherein step f. is carried out in a reduced oxygen environment.

D37. A method according to any one of items D1-D36, wherein step f. is carried out at a temperature of at least 600° C. for at least 10 minutes.

D38. A method according to any one of items D37, wherein step f. is carried out at 650-1000° C. for 10 minutes to 3 hours.

D39. A method according to any one of items D37 or D38, wherein step f. is carried out at 750-850° C. for 1 hour.

D40. A method according to any one of items D1-D39, wherein the weight ratio of composite material:pitting agent is 1:1.5 or higher.

D41. A method according to any one of items D1-D40, wherein the weight ratio of composite material:pitting agent is 1:2 to 1:10, for example 1:2.5 to 1:8, or 1:3 to 1:5.

D42. A method according to any one of items D1-D40, wherein the weight ratio of composite material:pitting agent is 1:3.

D43. A method according to any one of items D1-D42, wherein the pitting agent is potassium carbonate (K₂CO₃).

D44. A composite material obtainable by a method according to any one of items D1-D43.

E1. A fuel storage material comprising:
(i) a proton conducting polymeric material; and
(ii) a composite material comprising a superstructure of composite particles, wherein said superstructure comprises:
a scaffold of coalesced (N-doped) carbon nanofoam particles; and
a coating on the scaffold, said coating comprising N-doped graphitic carbon.

E2. The fuel storage material according to item E1, wherein the composite material is as described in any one of items C1-C17 or D44.

E3. The fuel storage material according to item E1 or E2, wherein the proton conducting polymeric material is capable of conducting protons at room temperature, i.e. at 25° C.

E4. The fuel storage material according to any one of items E1-E3, wherein the proton conducting polymeric material is an acid doped hydrogel.

E5. The fuel storage material according to item E4, wherein the hydrogel is doped with phosphoric acid.

E6. The fuel storage material according to item E4, wherein the hydrogel is doped with sulphuric acid.

E7. The fuel storage material according to any one of items E4-E6, wherein the acid dopant in the hydrogel is from 5-25 wt %.

E8. The fuel storage material according to any one of items E4-E7, wherein the acid dopant in the hydrogel is from 10-20 wt %.

E9. The fuel storage material according to any one of items E4-E8, wherein the hydrogel is polyvinyl alcohol.

E10. The fuel storage material according to any one of items E4-E8, wherein the hydrogel is poly(meth)acrylate.

E11. The fuel storage material according to any one of items E4-E8, wherein the hydrogel is collagen.

E12. The fuel storage material according to any one of items E4-E8, wherein the hydrogel is gelatine.

E13. The fuel storage material according to any one of items E4-E8, wherein the hydrogel is fibrin.

E14. The fuel storage material according to any one of items E4-E13, wherein the fuel storage material contains less than 15 wt % acid doped hydrogel.

E15. The fuel storage material according to any one of items E4-E14, wherein the fuel storage material typically contains from 4-12 wt % acid doped hydrogel.

E16. The fuel storage material according to any one of items E4-E15, wherein the fuel storage material typically contains from 5-10 wt % acid doped hydrogel.

E17. The fuel storage material according to any one of items E1-E3, wherein the polymeric material is a fluorinated acid polymer.

E18. The fuel storage material according to item E17, wherein the acidic group is attached directly to the side chains on the polymer backbone.

E19. The fuel storage material according to items E17 or E18, wherein the acidic group is selected from carboxylic acid groups, sulfonic acid groups, sulfonimide groups, phosphoric acid groups, phosphonic acid groups, and combinations thereof.

E20. The fuel storage material according to any one of items E17-E19, wherein the acidic group is selected from the group consisting of sulfonic acid groups, sulfonimide groups, and combinations thereof.

E21. The fuel storage material according to any one of items E17-E20, wherein the at least about 50% of the total number of halogen and hydrogen atoms in the polymer being fluorine atoms.

E22. The fuel storage material according to any one of items E17-E21, wherein at least about 75% of the total number of halogen and hydrogen atoms in the polymer being fluorine atoms.

E23. The fuel storage material according to any one of items E17-E22, wherein at least about 90% of the total number of halogen and hydrogen atoms in the polymer being fluorine atoms.

E24. The fuel storage material according to any one of items E17-E23, wherein the fluorinated acid polymer is perfluorinated.

E25. The fuel storage material according to any one of items E17-E24, wherein the polymeric backbone is selected from polyolefins, polyacrylates, polymethacrylates, polyimides, polyamides, polyaramids, polyacrylamides, polystyrenes, and copolymers thereof.

E26. The fuel storage material according to any one of items E17-E25, wherein the acidic groups are sulfonic acid groups.

E27. The fuel storage material according to any one of items E17-E25, wherein the acidic groups are sulfonimide groups.

E28. The fuel storage material according to item E27, wherein the sulfonimide group has the formula:

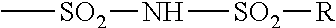

where R is an alkyl group.

E29. The fuel storage material according to item E17, wherein the acidic groups are on a fluorinated side chain.

E30. The fuel storage material according to item E29, wherein the fluorinated sides chains are selected from alkyl groups, alkoxy groups, amido groups, ether groups, and combinations thereof.

E31. The fuel storage material according to any one of items E17-E30, wherein the fluorinated acid polymer has a highly-fluorinated olefin backbone, with pendant highly-fluorinated alkyl sulfonate, highly-fluorinated ether sulfonate, highly-fluorinated ester sulfonate, or highly-fluorinated ether sulfonimide groups.

E32. The fuel storage material according to any one of items E17-E31, wherein the fluorinated acid polymer is a perfluoroolefin having perfluoro-ether-sulfonic acid side chains.

E33. The fuel storage material according to item E17, wherein the polymer is a copolymer of 1,1-difluoroethylene and 2-(1,1-difluoro-2-(trifluoromethyl) allyloxy)-1,1,2,2-tetrafluoroethanesulfonic acid.

E34. The fuel storage material according to item E17, wherein the polymer is a copolymer of ethylene and 2-(2-(1,2,2-trifluorovinyloxy)-1,1,2,3,3,3-hexafluoropropoxy)-1,1,2,2-tetrafluoroethanesulfonic acid.

E35. The fuel storage material according to item E17, wherein the polymer is a homopolymer or copolymer of a fluorinated and partially sulfonated poly(arylene ether sulfone).

E36. The fuel storage material according to item E17, wherein the fluorinated acid polymer is a sulfonimide polymer having Formula VII:

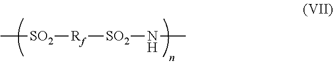

where:
   R_{f} is selected from highly-fluorinated alkylene, highly-fluorinated heteroalkylene, highly-fluorinated arylene, and highly-fluorinated heteroarylene, which may be substituted with one or more ether oxygens; and
n is at least 4.

E37. The fuel storage material according to item E36, wherein n is greater than 10.

E38. The fuel storage material according to item E17, wherein the fluorinated acid polymer has formula XI:

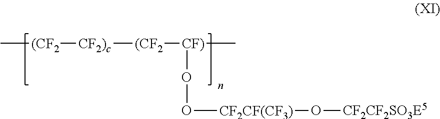

where
each c is independently 0 or an integer from 1 to 3;
n is at least 4; and
E⁵ is selected from hydrogen or a cation such as Li, Na, or K.

E39. The fuel storage material according to item E17, wherein the fluorinated acid polymer also comprises a repeat unit derived from at least one highly-fluorinated ethylenically unsaturated compound.

E40. The fuel storage material according to item E17, wherein the fluorinated acid polymer includes a highly-fluorinated carbon backbone and side chains represented by the formula:

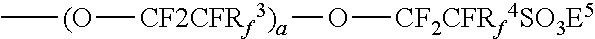

wherein
R_{f}³ and R_{f}⁴ are independently selected from F, Cl or a highly-fluorinated alkyl group having 1 to 10 carbon atoms,
a=0, 1 or 2, and
E⁵ is selected from hydrogen or a cation such as Li, Na, or K.

E41. The fuel storage material according to item E17, wherein the fluorinated acid polymer comprises a perfluorocarbon backbone and the side chain represented by the formula

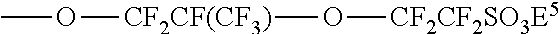

where
E⁵ is selected from hydrogen or a cation such as Li, Na, or K.

E42. The fuel storage material according to any one of items E17-E41, wherein the material contains less than 5 wt % fluorinated acid polymer.

E43. The fuel storage material according to any one of items E17-E42, wherein the material contains from 0.1 to 5 wt % fluorinated acid polymer.

E44. The fuel storage material according to any one of items E17-E43, wherein the material contains from 0.3 to 4 wt % fluorinated acid polymer.

E45. The fuel storage material according to any one of items E17-E44, wherein the material contains from 0.5 to 3 wt % fluorinated acid polymer.

E46. The fuel storage material according to any one of items E1-E45, wherein the material additionally comprises an Arrhenius acid.

E47. The fuel storage material according to E46, wherein the Arrhenius acid is sulphuric acid, phosphoric acid or nitric acid.

E48. The fuel storage material according to E46, wherein when the proton conducting material is a hydrogel, the Arrhenius acid is phosphoric acid.

E49. The fuel storage material according to E47, wherein when the proton conducting material is a fluorinated polymeric sulfonic acid-based material, the Arrhenius acid is sulphuric acid.

E50. The fuel storage material according to any one of items E1-E49, wherein the fuel storage material is capable of storing hydrogen at levels of over 1 wt %.

E51. The fuel storage material according to any one of items E1-E50, wherein the fuel storage material is capable of storing hydrogen at levels of over 2 wt %

F1. A method of making a fuel storage material, comprising:
(i) forming a paste of a composite material, proton conducting polymeric material and a dispersing agent, said composite material comprising a superstructure of composite particles, wherein said superstructure comprises:
a scaffold of coalesced (N-doped) carbon nanofoam particles; and
a coating on the scaffold, said coating comprising N-doped graphitic carbon;
(ii) pressing the paste into a compacted form; and
(iii) drying the compacted form.

F2. A method according to F1, wherein the paste is formed using water as the dispersing agent.

F3. A method according to item F1 or F2, wherein the polymeric material is an acid doped hydrogel.

F4. A method according to item F3, wherein step (i) comprises:
(a) forming a mixture of hydrogel-forming polymer, acid dopant and composite material;
(b) lyophilising the mixture; and
(c) adding water for form a paste of lyophilised conducting polymeric material and composite material.

F5. A method according to any one of items F1-F4, wherein step (iii) comprises heating the compacted form at a temperature high enough to facilitate removal of the dispersing agent, but low enough not to damage the proton conducting polymeric material.

F6. A method according to any one of items F1-F5, wherein the proton conducting material is a fluorinated acid polymer.

F7. A method according to item F6, wherein step (iii) comprises heating the compacted form at a temperature from 50 to 250° C.

F8. A method according to item F7, wherein step (iii) comprises heating the compacted form at a temperature from 100 to 200° C.

F9. A method according to item F7 or F8, wherein the heating is carried out in a flowing air stream to facilitate removal of the dispersing agent.

F10. A method according to any one of items F1-F5, wherein the proton conducting material is an acid doped hydrogel.

F11. A method according to item F10, wherein step (iii) comprises heating the compacted form at a temperature no higher than 75° C.

F12. A method according to any one of items F1-F11, wherein after step (iii), the material may be degassed.

F13. A method according to any one of items F1-F12, wherein after step (iii), the material may be degassed in a vacuum furnace.

F14. A method according to any one of items F1-F13, wherein the composite material is as described in any one of items C1-C17 or D44.

F15. A method according to item F1, wherein the fuel storage material formed is in accordance with any one of items E1-E51.

F16. A fuel storage material obtainable by a method according to any one of items F1-F15.

G1. A fuel cell comprising a fuel storage material according to any one of items E1-E51 or F16.

G2. A fuel cell according to item G1, wherein the fuel storage material is part of or adjacent to an electrode to provide, at least in part, said fuel to the electrode when operating in a redox mode.

G3. A fuel cell (100) comprising:
a polymer electrolyte membrane (101) having a first electrode (102) on one side and a second electrode (103) on an opposed side, wherein the polymer electrolyte membrane (101), the first electrode (102) and the second electrode (103) are arranged between a first plate (104) and a second plate (105);
wherein the first plate (104) is arranged adjacent the first electrode (102) and the second plate (105) is arranged adjacent the second electrode (105), wherein the first plate optionally defines, at least in part, flow channels facing the first electrode (102) and configured to provide fluid to and receive fluid from the first electrode (102);
one or more first catalyst layers between the first plate (104) and the polymer electrolyte membrane (101);
one or more second catalyst layers between the second plate (105) and the polymer electrolyte membrane (101);
wherein the fuel cell is configured to operate in a redox mode and a regenerative mode, wherein
   in the redox mode the fuel cell is configured to be provided with a fuel to the second electrode (103) and provided with oxygen to the first electrode (102) to generate an electric current between the first and second electrodes and a reaction product; and
   in the regenerative mode the fuel cell is configured to be provided with the reaction product to the first electrode (102) and a potential difference between the first and second electrodes thereby generating said fuel at the second electrode (103);
   and wherein
the fuel cell includes a fuel storage material as part of or adjacent to the second electrode (103) to provide, at least in part, said fuel to the second electrode (103) in the redox mode and/or store said fuel in the regenerative mode,
the fuel storage material comprising
   a composite material and a proton conducting polymeric material, said composite material comprising a superstructure of composite particles, wherein said superstructure comprises:
   a scaffold of coalesced (N-doped) carbon nanofoam particles; and
   a coating on the scaffold, said coating comprising N-doped graphitic carbon.

G4. The fuel cell of items G1-G3, wherein the proton conducting polymeric material is a fluorinated acid polymer.

G5. The fuel cell of item G4, wherein the material contains from 0.1 to 5 wt % fluorinated acid polymer.

G6. The fuel cell of items G1-G3, wherein the proton conducting polymeric material is an acid doped hydrogel.

G7. The fuel cell according to item G6, wherein the fuel storage material typically contains from 4-12 wt % acid doped hydrogel.

G8. The fuel cell according to any one of items G1-G7, wherein the material additionally comprises an Arrhenius acid.

G9. The fuel cell according any one of items G1-G8 further comprising one or more gas diffusion layers configured to promote, respectively, one or more of:
the diffusion of fuel to and/or from flow channels of the second plate;
the diffusion of oxygen, such as from air, to and/or from the flow channels of the first plate;
the diffusion of fuel or derivative thereof to and/or from the membrane; and
the diffusion of fuel or derivative thereof to and/or from the membrane.

G10. The fuel cell according to item G9, wherein the gas diffusion layer has a hydrophobic coating.

G11. The fuel cell according to any one of items G1-G10, wherein the first electrode comprises a carbon cloth.

G12. The fuel cell according to any one of items G1-G11, wherein the first electrode comprises a carbon paper.

G13. The fuel cell according to any one of items G1-G12, wherein the first electrode comprises a metal frit.

G14. The fuel cell according to item G9, wherein the gas diffusion layer comprises a porous structure of fibres or open-cell foam.

G15. The fuel cell according to any one of items G1-G14, wherein the first plate and the second plate are configured to contain, at least in part, the fuel, oxygen and reaction product within the fuel cell and none, one or more of:
comprise a rigid element to provide structural support for the first electrode, the membrane and the second electrode;
comprise conductive elements for electrically coupling to the first and second electrodes and to a circuit to transport electrons between the electrodes;
comprise a structure in which the first flow channels and second flow channels are formed.

G16. The fuel cell according to item G1-G15, wherein said fuel cell comprises a first electrode and a second electrode separated by a polymer electrolyte membrane and wherein said fuel storage material is arranged adjacent to or as part of the second electrode.

G17. A fuel cell stack comprising a plurality of fuel cells arranged in series, said plurality of fuel cells comprising at least one fuel cell according to any of items G1-G16.

G18. A fuel cell stack according to item G17, wherein the fuel cell stack does not comprise any cooling elements.

G19. A fuel cell according to item G1-G18, wherein the catalyst on the one or more first catalyst layer catalyses a OER and/or ORR reaction.

G20. The fuel cell according to any one of items G1-G19, wherein the second plate comprises flow channels formed in a surface thereof facing the second electrode and configured to provide fluid to and receive fluid from the second electrode.

G21. The fuel cell according to any one of items G1-20 claims, wherein the fuel cell comprises a gas diffusion layer between said polymer electrolyte membrane (101) and the second electrode (103).

G22. The fuel cell according to item G21, wherein the gas diffusion layer has a hydrophobic coating.

G23. The fuel cell according to item G21 or item G22, wherein the gas diffusion layer comprises a porous structure of fibres or open-cell foam.

G24. The fuel cell according to any one of items G1-G23, wherein the fuel cell is configured to receive hydrogen as said fuel via said flow channels of the second plate.

G25. The fuel cell according to any one of items G1-G24, wherein the fuel cell comprises a hydrogen fuel cell, wherein said fuel comprises hydrogen, said oxidant comprises air and said reaction product comprises water.

G26. The fuel cell according to any one items G1-G25, wherein the first electrode comprises a textile layer of electrically conductive fibres.

G27. The fuel cell according to item G26, wherein the fibres of the textile layer comprise a metal.

G28. The fuel cell according to item G26-G27, wherein the textile layer comprises a non-platinum-group metal.

G29. The fuel cell according to item G28, wherein the textile layer comprises a non-woven fabric.

G30. The fuel cell according to any one of items G1-G29, wherein the first plate and the second plate are configured to contain, at least in part, the fuel, oxygen and reaction product within the fuel cell and none, one or more of:
comprise a rigid element to provide structural support for the first electrode, the membrane and the second electrode;
comprise conductive elements for electrically coupling to the first and second electrodes and to a circuit to transport electrons between the electrodes;
comprise a structure in which the first flow channels and second flow channels are formed.

G31. The fuel cell according to any one of items G1-G30, wherein the fuel cell includes a peripheral gasket configured to be sandwiched between the first plate and the second plate and contain at least the polymer electrolyte membrane, the first electrode, the second electrode, the one or more first catalyst layers and the one or more second catalyst layers.

G32. A fuel cell stack comprising a plurality of fuel cells arranged in series, said plurality of fuel cells comprising at least one fuel cell according to any of items G1-G31.

H1. Use of a fuel storage material as defined in any of items E1-E51 or F16 in a fuel cell.

H2. Use of a fuel storage material as defined in any of items E1-E51 or F16 to store hydrogen.

H3. Use according to item H2, wherein the hydrogen is in the form of hydronium ions.

H4. Use according to item H3, wherein the hydrogen is stored via chemisorption.

H5. Use according to item H2, wherein the hydrogen is in the form of liquified hydrogen.

H6. Use according to item H5, wherein the hydrogen is stored via physisorption.

H7. Use according to item H2, wherein the hydrogen is in the form of hydronium ions and liquified hydrogen.

H8. Use according to item H7, wherein the hydrogen is stored via physisorption and chemisorption.

### Example 1—Preparation of N-Doped Carbon Nanofoam

171 g of table sugar was dissolved in 100 ml deionized (DI) water. The mixture was heated and stirred to dissolve the sugar until fully dissolved. The final temperature when the sugar becomes fully dissolved was approximately 60° C.-80° C.

The mixture was allowed to cool to approximately 45° C., and 3 mg of naphthalene was added. The mixture was stirred to dissolve the naphthalene.

The resultant mixture was added to a Teflon lined hydrothermal reactor. The reactor was sealed and placed into oven at 155° C. for 5 hours.

The resultant mixture was allowed to cool, then the carbonaceous material was removed and thoroughly cleaned using physical dissolution, decanting, and DI filtering of the material, sequentially in that order. The filtrate was dried under vacuum in an oven at 50° C. for 6-12 hrs.

The material was then milled in a ball mill for 24+ hrs using 5 mm-10 mm steel bearings (other bearings such as alumina or zirconium may also be used), then sieved through a 43-63 micron polyamide filter.

The resultant material was nitrogen doped by treating with 6 M HNO₃ for 8 h at 100° C., then neutralized using mild sodium bicarbonate solution and rinsing in DI water until pH of 6.5-7 is reached. The material was then dried under vacuum at 50° C. for 6-12 hrs.

SEM micrographs of the resultant material are shown in FIGS. 2a and 2b. The material is a scaffold of small particulate material having diameters of approximately 1-2 μm, which are coalesced to form a foamed porous material.

### Example 2—Preparation of a Carbon Nanofoam Material Coated with N-Doped Graphitic Carbon (Composite Material)

171 g of table sugar was dissolved in 100 ml deionized (DI) water. The mixture was heated and stirred to dissolve the sugar until fully dissolved. The final temperature when the sugar becomes fully dissolved was approximately 60° C.-80° C.

The mixture was allowed to cool to approximately 45° C., and 3 mg of naphthalene was added. The mixture was stirred to dissolve the naphthalene.

The mixture was added to a Teflon lined hydrothermal reactor. The reactor was sealed and heated in an oven at 69° C. for 5 hours.

The material was nitrogen doped by mixing with avian feathers (goose down) in a 50:50 (carbon material to feathers). The mixture was heated in a reduced oxygen environment (under argon flow) at 550° C. for 1 hr.

Once a composite material was formed, a pitting agent (K₂CO₃) was added to the mixture at a mass ratio of 1:3 composite material:pitting agent. The material was then dried and heated in a nitrogen environment at 800° C. for 1 hour.

Once done, the mixture was cooled and the carbonaceous material was removed. The material was thoroughly cleaned using physical dissolution, decanting, and DI filtering of the material, sequentially in that order. The filtrate was dried under vacuum in an oven at 50° C. for 6-12 hrs.

The material was then milled in a ball mill for 12 hrs using 5 mm-10 mm steel bearings (other bearings such as alumina or zirconium may also be used), then sieved through a 43-63 micron polyamide filter.

Cleaning and milling can optionally be repeated to provide the final product.

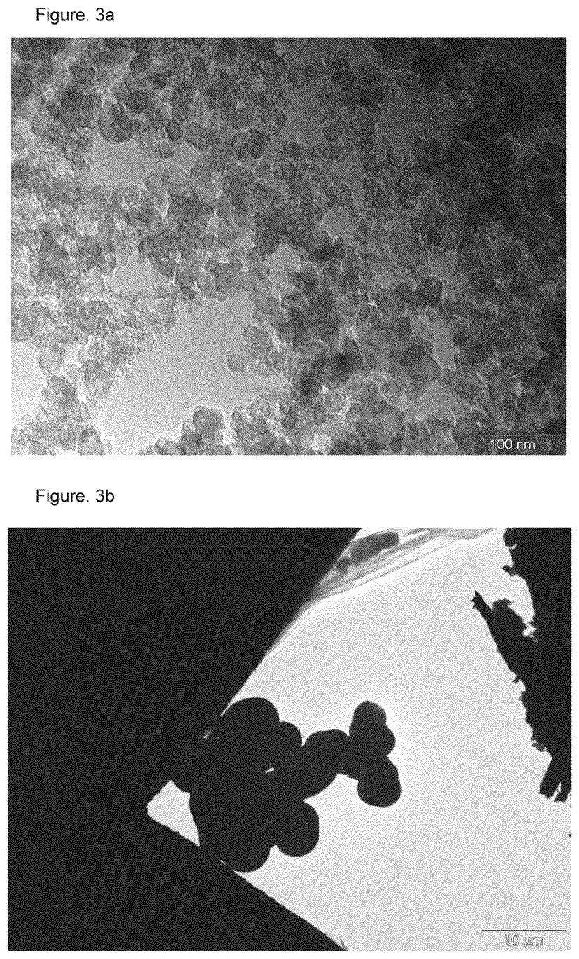

TEM micrographs of the resultant material, are shown in FIGS. 3a and 3b. The material is a superstructure of small particulate material having diameters of approximately 10-30 nm, which aggregate to form clusters of around 4-5 μm, shown in FIGS. 3a and 3b respectively.

In order to disperse the aggregates and image the individual particles, an ionic solvent is added to the sample, for example isopropyl alcohol.

### Example 3—Fuel Storage Material

20 ml of DI water was added to 100 g of composite material from Example 2. 1% wt of 60% EtOH Nafion® 212 solution is added to carbon nanofoam solution. The material is paddle mixed to ensure a consistent dispersion.

The solution was pressed into sheets of 2-3 mm in thickness (depending on the active surface area of the end battery model). Electrode sheets were then exposed to a dehumidified dry-air stream at 150° C. with a residence time of 2 minutes. Infrared Radiant Heating is used as the heating mechanism.

The pre-heated electrode sheets were then passed into a vacuum furnace at 70° C. for 6 hrs at 101 kPa to de-gas the material.

After de-gassing the material the sheets were soaked in 1M H₂SO₄ for 8-12 hrs. After the soaking stage the material is dried at ambient temperature for 24 hrs to evaporate the excess water, but not to remove all the water content. An estimated minimum of 5000 ppm of water content is required for proton conductivity.

The material was then cut into the required shape.

### Example 4—Estimation of Storage Potential

The hydrogen storage potential of the N-doped carbon nanofoam with N-doped graphitic carbon (composite material) was estimated from the discharge time of a fuel cell comprising the composite material in a fuel storage electrode. The result was compared to other known carbon nanofoam materials.

TABLE 1
Details of fuel storage materials A-E

| Storage material | Details |
|---|---|
| A -Carbon nanofoam | According to steps i and ii (no N-doping) |
| B - Activated carbon | Powder Activated Carbon 80 Mesh from |
| | Carbon Activated Corp; Thornbury, |
| | Bristol |
| C - Black Pearls ® 2000 | Commercially available form of carbon |
| | black |
| D - Composite material | N-doped carbon nanofoam treated with |
| | structural protein according to steps a-e |
| | and g |
| E - Activated | N-doped carbon nanofoam treated with |
| composite material | structural protein and pitting agent |
| | according to Example 2 |

To form the electrodes, each of the materials was combined with Nafion® 212 (5-10%) and soaked in 1M H₂SO₄ to activate the Nafion. The amount of fuel storage material in each test cell was standardized at 1 g.
Test cell dimensions: 3 cm×3 cm
Active surface area: 9 cm²
Catalyst: Pt—C, 20% platinum on carbon (purchased from fuelcellstore: 20% Platinum on Vulcan XC 72, Product Code: 591278)
Polymer activating agent: 1M H₂SO₄
PEM: Nafion® 115
Fuel: 10 mL water
Exacting time: 1 min
Load: 100 mA

Table 2 shows the discharge time for each of the carbon nanofoam materials. Storage materials D and E show a significantly longer discharge time than materials A, B and C. This is indicative of a higher hydrogen storage capacity for materials D and E, with material E having the best performance.

Without wishing to be bound by theory, it is thought that materials D and E have better hydrogen storage capabilities due to a higher surface area and a degree high N-doping. The high degree of N-doping allows for easy absorption of the hydronium form of hydrogen. For example, the hydrogen may be stored as H₃O⁺, H₅O₂⁺ or H₉O₃⁺, wherein temporary ions bonds are formed between the ions and the storage material.

TABLE 2
Discharge time for fuel storage materials A-E

| Storage Material | Discharge Current | Discharge Time |
|---|---|---|
| A | 0.7 V × 100 mA/0.07 W | 4 min 11 sec |
| B | 0.7 V × 100 mA/0.07 W | 4 min 38 sec |
| C | 0.7 V × 100 mA/0.07 W | 5 min 45 sec |
| D | 0.7 V × 100 mA/0.07 W | 7 min 44 sec |
| E | 0.7 V × 100 mA/0.07 W | 10 min 32 sec |

Based on the discharge time, it is estimate that samples D and E store around 1-2% hydrogen.

1. A fuel cell comprising a fuel storage material, wherein the fuel storage material comprises:
(i) a proton conducting polymeric material; and
(ii) a composite material comprising a superstructure of composite particles, wherein said superstructure comprises:
a scaffold of coalesced carbon nanofoam particles; and
a coating on the scaffold, said coating comprising N-doped graphitic carbon;
wherein the carbon nanofoam particles may optionally be N-doped.

2. The fuel cell of claim 1, wherein the fuel storage material is part of or adjacent to an electrode to provide, at least in part, said fuel to the electrode when operating in a redox mode.

3. The fuel cell of claim 1, wherein the composite material comprises composite particles, the composite particles having a diameter of from 0.005 to 25 μm.

4. The fuel cell of claim 1, wherein the N-doped graphitic carbon is covalently bound to the (N-doped) carbon nanofoam scaffold.

5. The fuel cell of claim 1, wherein the (N-doped) carbon nanofoam particles are N-doped carbon nanofoam particles.

6. The fuel cell of claim 1, wherein the composite material has an N content of from 1 to 5 wt %.

7. The fuel cell of claim 1, the scaffold of coalesced (N-doped) carbon nanofoam particles having a tortuous path of open pores at least 3 times the average diameter of the nanofoam particles.

8. The fuel cell of claim 7, wherein the composite material has N-doped graphitic regions that are located in the open pores of the scaffold of coalesced (N-doped) carbon nanofoam particles.

9. A fuel cell as defined in claim 1, wherein the composite material has a surface area of from 900 to 2000 m²/g.

10. The fuel cell as defined in claim 1, wherein the proton conducting polymeric material is an acid doped hydrogel.

11. The fuel cell as defined in claim 1, wherein the polymeric material is a fluorinated acid polymer.

12. A fuel cell stack comprising a plurality of fuel cells arranged in series, said plurality of fuel cells comprising at least one fuel cell according to claim 1.

13. A method of making a composite material as used in claim 1, the method comprising the steps of:
a. forming a mixture of sugar, water and hydrocarbon mediator;
b. heating the mixture to form a carbon nanofoam material;
c. optionally heating the carbon nanofoam in the presence of an acidic nitrogen source (such as nitric acid) to form an N-doped carbon nanofoam;
d. optionally comminuting the (N-doped) carbon nanofoam material;
e. heating the (N-doped) carbon nanofoam material with a structural protein in a reduced oxygen environment to form a composite material;
f. optionally treating the composite material with a pitting agent to form an activated composite material; and
g. optionally comminuting the material.

14. The method of claim 13, wherein the structural protein is collagen, gelatine or keratin, preferably wherein the structural protein is feathers, even more preferably wherein the structural protein is avian feathers.

15. A composite material comprising a superstructure of composite particles, wherein said superstructure comprises:
a scaffold of coalesced (N-doped) carbon nanofoam particles; and
a coating on the scaffold, said coating comprising N-doped graphitic carbon.

16. The composite material of claim 15, wherein the N-doped graphitic carbon is covalently bound to the (N-doped) carbon nanofoam scaffold.

17. The composite material of claim 15, wherein the (N-doped) carbon nanofoam particles are N-doped.

18. The composite material of claim 15, wherein the N content of the material is 2 wt % or more.

19. A fuel storage material comprising:
(i) a proton conducting polymeric material; and
(ii) the composite material of claim 15.
